(19) United States
(12) Patent Application Publication
(10) Pub. No.: US 2006/0144769 A1
(43) Pub. Date: Jul. 6, 2006

(54) Greywater recycling system

(76) Inventor: Pal Okros, Budapest (HU)

Correspondence Address: BIRCH STEWART KOLASCH & BIRCH, PO BOX 747, FALLS CHURCH, VA, 22040-0747, US

(21) Appl. No.: 10/540,475

(22) PCT Filed: Dec. 23, 2002
(86) PCT No.: PCT/HU02/00164

§ 371 Date: Jan. 3, 2006

(51) Int. Cl. B01D 17/02

(52) U.S. Cl. 210/123; 210/167; 210/136; 4/317; 4/318

(57) ABSTRACT

The subject of the invention is a greywater recycling system, primarily for the economical flushing of toilets, consisting of one or more tanks (1), bath tub (22), a washing machine (30) provided with a primary water pump (21), water supply pipe (3), greywater pipe (19), flushing conduit (8), flushing valve (7), and in the tank (1) a floating ball (6). The characteristic feature of the invention is that the floating ball (6) is fixed by means of a pivoted support arm (16) to the side wall of the tank (1) allowing it to swing in vertical plane, there is a greywater column (11) above the floating ball (6), and an actuating shaft (15) fixed onto the floating ball (6), the actuating shaft (15) passing through the greywater column (11) above the floating ball (6) is connected to the clean water fill valve (4) of the water supply pipe (3).

The subject of the invention is a greywater recycling system, primarily for the economical flushing of toilets, consisting of one or more tanks, bath tub, a washing machine provided with a primary water pump, greywater pipe, flushing conduit, flushing valve, and in the tank a floating ball.

The traditional flushing toilet constructions are described in detail on the pages 593-599 of the book “Water supply, canalization, gas supply of buildings” (written by Ballai and Marton, published by Müszaki Könyvkiadó, Budapest, 1977). The traditional overfeed flushing toilet consists of an open tank with a capacity of about 8 litre, a float valve, and a weighted flushing valve. The pivoted support arm of the float valve closes directly the fill valve, the upper part of the floater is floating on the surface of the water. The disadvantage of those flushing constructions is that they use potable water, which is becoming more and more valuable and expensive. As freshwater reserves of the Earth have become less available, the need to reuse part of the domestic waste-water has arisen. The waste-water produced by washing machines, bath tub and shower is called grey-water.

There are a number of known grey-water reusing equipments. The technical solution as per the U.S. Pat. No. 5,201,082 is grey-water for flushing toilet. It does not use clean water, so the use of greywater and clean water is not combined, and no mention is made about enlarging the tank.

The technical solution as per the U.S. Pat. No. 5,406,657, uses the standard flushing tank, and in addition to it a greywater collecting tank is used from which the grey-water is pumped into the flushing tank if the water level does not reach the maximum level in it. It does not use clean water, so the use of greywater and clean water is not combined, and no mention is made about enlarging the tank.

According to the U.S. Pat. No. 5,406,657 a tube connected to the sink-hole of the wash basin conducts the greywater to the traditional sized flushing tank, which is located directly above the toilet bowl. The sink-hole of the wash basin (or shower, etc.) must be at a level higher than the inlet hole of the tank—which can include the dwelling floor level difference, so that the greywater could flow into the tank by gravity free-fall. The clean water fill valve is omitted from the tank, consequently, if there is no sufficient quantity of greywater—which can be seen through a sight glass—the tank can be filled up by opening the tap of the wash basin. Thus filling the tank is not automatic.

The U.S. Pat. No. 4,017,395 uses a separate tank-system for treating greywater, including solid-liquid separator tank, disinfecting tank, etc. The size of the flushing tank is not enlarged, and flushing is not combined with clean water.

The technical solution as per the description of the U.S. Pat. No. 4,115,876 is using a separate holding tank from where the raw waste water is pumped into a combined sterilization and flocculation cell unit, then it is pumped into another tank, and only after that is it pumped into the flushing tank. The system is conceived for toilets on different vehicles, such as for ship or for mobile home. The black water must be pumped many times from one tank into the other. The aim of the system is to reuse the same waste-water following its treatment many times for the flushing of toilets. The size of the toilet tank is not enlarged, and it is not combined with clean water.

The greywater reusing systems as per the U.S. Pat. No. 5,406,657 and U.S. Pat. No. 5,243,719 descriptions describe a piping connected to the sink-hole of the wash basin or of the shower, which conducts the greywater through separate tanks to the toilet flushing tank. Besides the flushing tank, it uses one or more separate greywater tanks. The size of the toilet tank is not enlarged, and it is not combined with clean water.

The U.S. Pat. No. 5,341,529 for reusing greywater for flushing toilets, without enlarging the size of the “primary” flushing tank of the traditional flushing toilet, is applying a separate “auxiliary tank”, which is located right above the primary tank. The primary flushing tank is using clean water, too, for flushing. The greywater is sent to the auxiliary tank by a water pump. The use of clean and greywater is already combined, but in two separate tanks.

The subject of the CA 2,093,247 description is a technical solution which is a combined giant flushing toilet tank reusing greywater, into which the greywater is flowing by gravitation free-fall from an upper dwelling floor. If the water in the tank is not enough for one flushing, the invention, besides reusing greywater, uses clean water as well for flushing. However, the clean water fill valve is located in a distance from the bottom of the tank which is the maximum level for clean water, measuring the volume of water enough for one flushing. This means, that if the greywater level is even slightly over the one-flush volume level, which is generally the case, the clean-water fill valve is practically always submerged in waste-water. In case of a failure of the clean-water fill valve the waste-water can infiltrate into the clean-water supply piping, since the water pressure in a completely filled up tank can be higher than the water pressure inside the clean-water supply pipe. Due to the above, this solution can not be considered hygienic. Furthermore, the tank is conceived to use greywater outside the household, originating from other neighbouring households, which may raise concern, since the user is not likely to readily receive into her/his home the waste-water of other households. The utilization of the tank takes into account only the greywater originating from washing oneself, which accounts for about 30% of household water consumption, but it does not target use of the greywater originating from the washing machine which represents a further 20% approximately. Toilet flushing accounts about 40% of household water consumption for.

The aim of the invention is to eliminate the disadvantages of the technical solutions known up to date, and to develop a greywater recycling system which is operating automatically, recycles the greywater from the washing machine, as well, and makes use of greywater accumulating only within the same household, furthermore, which is simple and inexpensive.

The basic idea of the invention is the recognition that the implementation of the measures described in the claim 1 will result in a system which is more advantageous than the previous ones.

The greywater recycling system, in accordance with the stipulated target, primarily for the economical flushing of toilets, consisting of one or more tanks, bath tub, a washing machine provided with a primary water pump, water supply pipe, greywater pipe, flushing conduit, flushing valve, and in the tank a floating ball, is built up in a way that the floating ball is fixed by means of a pivoted support arm to the side wall of the tank allowing it to swing in vertical plane, and an actuating shaft fixed onto the floating ball, passing through the greywater column above the floating ball is connected to the clean water fill valve of the water supply pipe.

It may be typical that the washing machine being connected to the bath tub with a greywater suction pipe is provided with a secondary water pump, which, in turn, is connected to the tank by means of a secondary greywater drain pipe. There is an in-line water sensing unit mounted before the secondary water pump enabling it to start automatically, and after the drain orifice a non-return valve is mounted into the secondary greywater drain pipe.

In one version of the invention, there is a stopping member fixed to the side wall of the tank, determining the position of the floating ball closing the clean water fill valve as well as the ratio of greywater and clean supply water. The primary water pump is connected to the tank by means of the primary greywater drain pipe, which is also provided with a non-return valve.

In further possible versions the greywater tube is connected with a greywater valve to the primary greywater drain pipe, and in given cases to the secondary greywater drain pipe. On the outlet of the greywater pipe there are one or more filtering units suitably mounted within the tank. The tank has a compensating air orifice for the compensation of the atmospheric pressure. The tank is provided with an overflow tube, the diameter of which is greater than or equal to that of the greywater pipe.

The greywater recycling system as per the present invention has numerous advantages. Its operation is fully automatic, thus needs no human intervention whatsoever. In case the large combined tank is overfilled, the greywater surplus flows automatically to the toilet bowl through the overflow tube. Inasmuch as there is not enough greywater for one flushing, the system provides fresh water supply automatically. It is operating with pumps as well, therefore it is not absolutely necessary to found its operation on gravity free-flow due to dwelling floor differences, and it is using only the grey-water originating within one and the same household. The water pumps are located in as safe place inside the washing machine, thus no additional power supply is needed. The system is simple to install, and its manufacturing is economical, since it consists of parts the majority of which is well-known.

In the following, the invention is presented in detail with examples of technical solutions on basis of drawings. The attached drawings present the following:

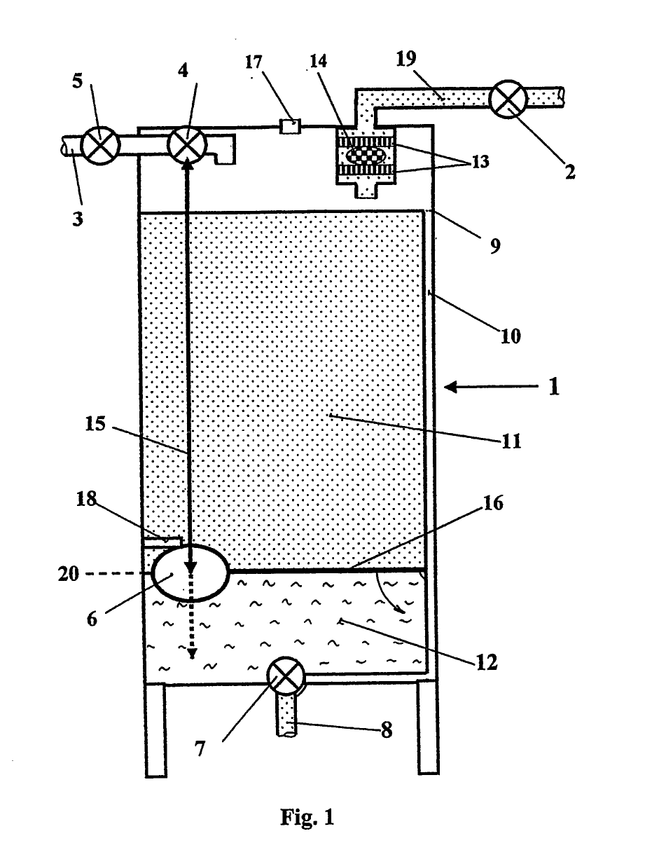

FIG. 1 shows the longitudinal section of the tank,

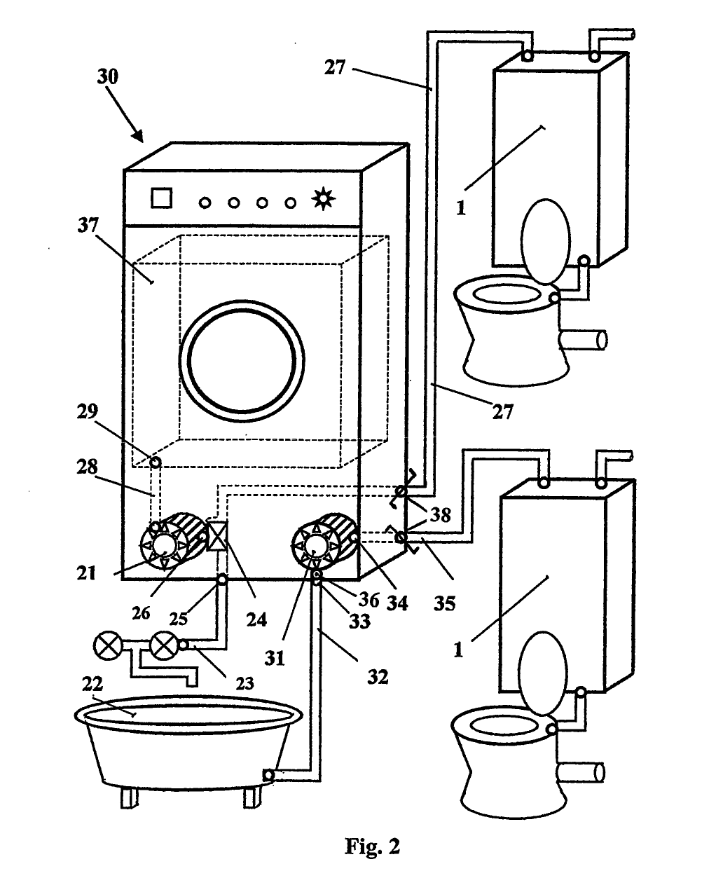

FIG. 2 shows a possible version of the system.

FIG. 1 shows the 1 tank, the 2 greywater valve, the 3 water supply pipe, the 4 fill valve, the 5 shut-off valve, the 6 floating ball, the 7 flushing valve, the 8 flushing conduit, the 9 overflow orifice, the 10 overflow tube, the 13 filtering units, the 14 disinfecting unit, the 15 actuating shaft, the 16 pivoted support arm, the 17 compensating air orifice, the 18 stopping member, and the 19 greywater pipe.

The 1 tank can have various dimension, the 100 litre size is advantageous. The greywater arriving through the 19 greywater tube is directed through the 13 filtering unit, consisting of a metal pre-filter screen and a finer filter. This filters out possible pieces of hair, and threads or fluffs. The 14 disinfecting unit chlorinates the greywater. The treated greywater flows into the 1 tank. Inasmuch as the water quantity exceeds the capacity of the 1 tank, the 11 greywater surplus flows through the 9 overflow orifice and the 10 overflow tube and exits the tank through the 8 flushing conduit. The diameter of the 10 overflow tube is identical to or greater than that of the 19 greywater tube. When flushing, by opening the 7 flushing valve the quantity of water necessary for the flushing—about 6-7 litres—is leaving the tank through the 7 flushing valve and the 8 flushing conduit. The 11 greywater can mix with the 12 supply water. If there is a sufficient quantity of 11 greywater present the location of the 6 floating ball is fixed at the 20 supply water level.

The 6 floating ball comes into action when the 1 tank does not contain 11 greywater, or the water quantity in the 1 tank sinks below the level of about 6-7 litres determined by the 18 stopping member. In such a case, the 16 pivoted support arm swings downward, the 15 actuating shaft on its turn opens the 4 fill valve. Fresh 12 supply water flows into the 1 tank through the 3 water supply pipe and the 4 fill valve. The inflowing 12 supply water pushes the 6 floating valve upwards, also moving upwards the 15 actuating shaft, which closes the 4 fill valve. At that moment, the 6 floating ball is at the 20 supply water level. If after that 11 greywater flows into the tank, the 6 floating ball can no more rise upwards, because it bumps into the 18 stopping member, so it remains at the 20 supply water level.

Limiting the upward movement of the 6 floating ball is also possible at the articulating joint where the 16 pivoted support arm is fixed to the 1 tank. In this way, the 12 supply water can flow into the 1 tank only when the water quantity in the 1 tank is below the volume sufficient for one flushing. In the 1 tank the atmospheric pressure and the steady flowing out of the flushing volume is ensured by the 17 compensating air orifice.

FIG. 2 shows the 1 tanks, the 21 primary water pump, the 22 bath tub, the 23 supply pipe connection, the 24 solenoid valve, the 25 water supply connection, the 26 outflow orifice, the 27 primary greywater drain pipe, the 28 washing space connecting duct, the 29 washing space connection, the 30 washing machine, the 35 secondary greywater drain pipe, the 36 water sensor, the 37 washing space and the 38 non-return valve. FIG. 2 shows two pieces of 1 tank, but the number of tanks can be one or more. In case of one tank, the 27 primary greywater drain pipe and the 35 secondary greywater drain pipe can be connected.

The 21 primary water pump is the original water pump of the 30 washing machine. It is required that the power and the lifting height of the 21 primary water pump is increases to exceed those of the pump types presently used in washing machines, in function of the dwelling floor difference and the distance to the 1 tank. The power of the electric centrifugal pumps most widely used in washing machines is about 100 W. The increased power of the 21 primary water pump is between 100 and 400 W, preferably 200 W, its increased water pressure is between 0.4 and 1.0 bar. The 31 secondary water pump incorporated into the 30 washing machine is preferably in the upper segment of the above mentioned power range, preferably 400 W, and its water pressure is between 0.5 and 1 bar. Its power supply in ensured by the power supply of the 30 washing machine, in a way that it is working automatically, and it is completely independent of all the original functions of the 30 washing machine.

The 31 secondary water pump is activated by the 36 water sensor—that can be enabled/disabled by a separate switch—and it comes into action when water arrives and sensed in the 32 greywater suction pipe. The 36 water sensor is optimally located between the 31 secondary water pump and the 33 suction pipe connection. The 38 non-return valves prevent backflow of the greywater. The greywater from the 30 washing machine is pumped through the 29 washing space connection, the 28 washing space connecting duct, the 21 primary water pump, the 26 outflow orifice, the 38 non-return valve and the 27 primary greywater drain pipe to the 1 tank. The water supply of the 30 washing machine is also indicated, through the 23 supply pipe connection, the 25 water supply connection, and the 24 solenoid valve. The greywater from the 22 bath tub is drained through the 32 greywater suction pipe, the 33 suction pipe connection, the 36 water sensor, the 34 drain orifice, the 38 non-return valve and the 35 secondary greywater drain pipe into the 1 tank.

Under the protection of the patent other versions of the present system are also possible. As an example, the 7 flushing valve can be mounted on the 8 flushing conduit in the W.C. on a different floor, and not on the lower part of the 1 tank which 1 tank may be located in the attic. The greywater recycling system of the present invention provides the solution primarily for the automatic recycling of greywater originating in the households from washing machine and the bath tub by reusing the greywater for flushing the toilet.

1. Greywater recycling system, primarily for the economical flushing of toilets, consisting of one or more tanks (1), bath tub (22), a washing machine (30) provided with a primary water pump (21), water supply pipe (3), greywater pipe (19), flushing conduit (8), flushing valve (7), and in the tank (1) a floating ball (6) is characterised, that the floating ball (6) is fixed by means of a pivoted support arm (16) to the side wall of the tank (1) allowing it to swing in vertical plane, there is a greywater column (11) above the floating ball (6), and an actuating shaft (15) fixed onto the floating ball (6), the actuating shaft (15) passing through the greywater column (11) above the floating ball (6) is connected to the clean water fill valve (4) of the water supply pipe (3).

2. Greywater recycling system according to claim 1, wherein the washing machine (30) being connected to the bath tub (22) with a greywater suction pipe (32) is provided with a secondary water pump (31), which secondary water pump (31), is connected to the tank (1) by means of a secondary greywater drain pipe (35).

3. Greywater recycling system according to claim 2, wherein there is an in-line water sensor (36) mounted before the secondary water pump (31) enabling the secondary water pump (31) to start automatically, and a non-return valve (38) is mounted into the secondary greywater drain pipe (35).

4. Greywater recycling system according to claim 1, wherein there is a stopping member (18) fixed to the wall of the tank (1), determining the uppermost position of the floating ball (6) closing the clean water fill valve (4) as well as the ratio of greywater (11) and clean supply water (12).

5. Greywater recycling system according to claim 1, wherein the primary water pump (21) is connected to the tank (1) by means of the primary greywater drain pipe (27), which primary greywater drain pipe (27) is provided with a non-return valve (38).

6. Greywater recycling system according to claim 1, wherein the greywater tube (19) is connected through the greywater valve (2) to the primary greywater drain pipe (27), and in given cases to the secondary greywater drain pipe (35).

7. Greywater recycling system according to claim 1, wherein on the outlet of the greywater pipe (19) there are one or more filtering units (13) suitably mounted within the tank (1).

8. Greywater recycling system according to claim 1, wherein the tank (1) has a compensating air orifice (17) for the compensation of the atmospheric pressure.

9. Greywater recycling system according to claim 1, wherein the tank (1) is provided with an overflow tube (10), the diameter of which is greater than or equal to that of the greywater pipe (19).

10. Greywater recycling washing machine together with greywater tank, for the economical flushing of toilets, consisting of a combined Greywater WC tank (1) built together in one single body unit with a washing machine (30) provided with a primary and secondary water pumps (21,31), having a filtering and disinfecting unit (13,14), having a compensating air orifice (17) and overflow tube (10), having a water supply pipe (3), said unit connected to the bath tube (22) with a greywater pipe (19), said unit having a flushing conduit (8), flushing valve (7), and in the combined Greywater WC tank (1) a floater (6), wherein the floater (6) is fixed by means of a support in the lower part of the tank (1) allowing it to move in vertical plane, there is a greywater column (11) above the floater (6), and an actuating shaft (15) fixed onto the floater (6), the actuating shaft (15) passing through the greywater column (11) above the floater (6) is connected to the clean water fill valve (4) of the water supply pipe (3) and the central electronic control unit is connected to the primary and secondary water pumps (21, 31) as well as to the A, B, C, X, Y and Z electro-magnetic valves, to the inline water sensor (36), to the overflow sensor in the tank, to the adjusting selector button mounted on the washer, to the greywater selector switch button, to the clean water flushing selector button, to the timer adjusting switch, to the overflow sensor, to the toilet occupancy sensor and to the flush activating unit.

11. Greywater recycling washing machine together with greywater tank according to claim 1, wherein more than one tank (1), is connected to the system.

12. Greywater recycling washing machine together with greywater tank according to claim 1, wherein the floater (6) can be of any shape in the tank (1) which floater (6) is on the floater guiding axle (39) provided with a limiting element (40), and which floater (6) is fixed, to the bottom of the tank (1) by chain or other filament (41).

13. Greywater recycling washing machine together with greywater tank according to claim 1, wherein the tank (1) is built in one single unit with the washer (30) thus forming one and the same body.

14. Greywater recycling washing machine together with greywater tank according to claim 1, wherein the water supply pipe (3) has a water spray function after the water fill valve (4) to spray water to the inner sides of the tank (1).

15. Greywater recycling washing machine together with greywater tank according to claim 1, wherein the washer (30) is equipped with one or two water pumps (21, 31) having the output of more than 100 W having a pressure output of more than 0.4 bar, and connected to a tank (1) by a greywater pipe (19).

16. Greywater recycling washing machine together with greywater tank according to claim 1, wherein the greywater suction pipe (32) and the primary greywater drain pipe (27) is equipped with a water diversion Suldi valve diverting the water to the sewage canal, and the top of the housing of the filters (13) is connected by a diverting tube to the overflow tube (9, 10).

17. Greywater recycling washing machine together with greywater tank according to claim 1, wherein the washer (30) is equipped with one or two water pumps (21, 31) having the output of 100 W to 400 W, having a pressure output of 0.4 to 1 bar, and connected to the bath tube (22), with a greywater suction pipe (32) and also connected to a WC flushing tank (1) by means of a greywater drain pipe.

18. Greywater recycling washing machine together with greywater tank according to claim 1, wherein the single water pump (21) of the washer (30) has three inflow orifices each of which has an electro-magnetic valve before the water pump (21):
on the supply pipe (23) the “All” clean water inlet valve,
on the washing space outlet pipe (28b) the “B” washing water inlet valve,
on the greywater suction pipe (32) the “C” bathing water inlet valve,
and the water pump (21) also has two outflow orifices, each of which is provided with an electro-magnetic valve after the water pump (21):
“X” clean water outlet valve on the washing space inlet pipe (28a),
“Y” greywater outlet valve on the greywater drain pipe (27, 35), which valves can be opened and closed in pairs. The simultaneous opening of “A” and “X” electromagnetic valves allows the inflow of clean water. The simultaneous opening of “B” and “Y”, valves allows the outflow of the greywater from washing, and the simultaneous opening of “C” and “Y” allows the drainage of greywater from the bath tube.

19. Greywater recycling washing machine together with greywater tank according to claim 1, wherein the washer (30) is equipped with a two-directional water pump (42), which has three orifices before the water pump (42) each of which has an electromagnetic valve (42):
on the supply pipe (23) the “A” clean water inlet valve in direct flow operation, on the greywater suction pipe (32) the “C” bathing water inlet valve in direct flow operation,
on the greywater drain pipe (27, 35) the “Z” greywater outlet valve in reverse flow operation, and the two-directional water pump (42) also has two orifices after the two-directional water pump (42), each of which is provided with an electro-magnetic valve:
“X” clean water valve on the washing space connection pipe (28a), which is a clean water inlet valve in direct flow operation, and in reverse flow operation “X” valve is grey water drain valve,
“Y” greywater outlet valve on the greywater drain pipe (27, 35) in direct flow operation; which valves can be opened and closed coupled in pairs. The simultaneous opening of “A” and “X” electro-magnetic valves in direct flow operation allows the inflow of clean water. The simultaneous opening of “X” and “Z” valves in reverse flow operation allows the outflow of the greywater from washing, and the simultaneous opening of “C” and “Y” in direct flow operation allows the drainage of greywater from the bath tube.

20. Greywater recycling washing machine together with greywater tank according to claim 1, wherein the support arm (16) holding the floater (6) in the tank (1) is connected directly to the clean water fill valve (4) on the clean water supply pipe (3), which clean water supply pipe goes through the greywater column (11) which is above the floater (6) then overhangs above the greywater column (11), and the clean water supply orifice (3a) is above the greywater column (11).

21. Greywater recycling washing machine together with greywater tank according to claim 1, wherein the toilet dual flushing operating unit is connected to said washer pump(s) and is controlled with the simultaneous operation of said inlet and outlet valves in pairs, by the central electronic control unit of the washer.

22. Greywater recycling washing machine together with greywater tank according to claim 12, wherein there is a sensor mounted near the toilet to detect if the toilet is in use, said sensor is connected to the control unit of the washer, emitting possible signals about toilet occupancy, said possible occupancy signals having suspending effect on greywater processing activity.

23. Greywater recycling washing machine together with greywater tank according to claim 12, wherein there is an overflow sensor mounted within the greywater tank of the washer, said overflow sensor connected to the control unit of the washer, providing possible signal for actuating said pump and water valves to empty the graywater surplus within the greywater tank into the toilet.

24. Greywater recycling washing machine together with greywater tank according to claim 12, wherein an adjusting selector button mounted on the washer and connected to the control unit of the washer, said selector button determining that washing water and/or first rinsing water and/or second rinsing water can go into the graywater tank on top of the washer or directed into the toilet.

25. Greywater recycling washing machine together with greywater tank according to claim 12, wherein a greywater selector switch button mounted on the washer and connected to the control unit of said washer, said greywater selector switch determining greywater flushing quantity.

26. Greywater recycling system according to claim 12, wherein a clean water flushing selector button mounted on said washer and connected to said control unit of the washer, said clean water flushing selector button determining the clean water quantity to flush with following flushing action by greywater,

27. Greywater recycling washing machine together with greywater tank according to claim 12, wherein there is a timer adjusting switch on the washer connected to said control unit of said washer, said timer adjusting switch connected to a control lamp and buzzer, said timer adjusting switch determining the time period after which said control lamp and buzzer is activated reminding to check filters and disinfecting agent in the filtering-disinfecting unit.

28. Greywater recycling washing machine together with greywater tank according to claim 12, wherein there is a flush activating unit mounted near the toilet, said flush activating unit connected to the control unit of said washer, said flush activating unit consisting of two activators, one for smaller and the other one for larger quantity of greywater flushing.

29. Greywater recycling washing machine together with greywater tank according to claim 12, wherein the top of the greywater tank built on top of said washer is a removable lid enabling easy access to the inside of said tank and to its mechanical and electronical components for the purpose of easy maintenance.
